(19) United States
(12) Patent Application Publication
(10) Pub. No.: US 2014/0000441 A1
(43) Pub. Date: Jan. 2, 2014

(54) INFORMATION PROCESSING APPARATUS, INFORMATION PROCESSING METHOD, AND PROGRAM

(71) Applicant: Sony Corporation, Tokyo (JP)

(72) Inventor: Yasushi MIYAJIMA, Kanagawa (JP)

(73) Assignee: Sony Corporation, Tokyo (JP)

(21) Appl. No.: 13/894,540

(22) Filed: May 15, 2013

(30) Foreign Application Priority Data
Jun. 27, 2012 (JP) 2012-143954

(51) Int. Cl. G10H 1/00

(52) U.S. Cl. CPC G10H 1/0008
USPC 84/609

(57) ABSTRACT

There is provided an information processing apparatus including a data acquiring unit that acquires section data identifying chorus sections among a plurality of sections included in a musical piece, a determining unit that determines a standard chorus section among the chorus sections identified by the section data according to a predefined determination condition for discriminating the standard chorus section from a non-standard chorus section, and a setting unit that sets an extraction range at least partially including the determined standard chorus section to the musical piece.

### BACKGROUND

The present disclosure relates to an information processing apparatus, an information processing method, and a program.

In the past, for example, in a musical piece delivery service, in order to help a user determine whether or not to purchase a musical piece, a shortened version for trial listening is provided to the user separately from a version to be finally sold. Generally, a part of a musical piece is clipped to generate the shortened version. In a musical piece delivery service, since a large number of musical pieces are dealt with, it is not realistic for an operator to individually indicate a part of a musical piece to be clipped. In this regard, typically, a part corresponding to a fixed temporal range (for example, 30 seconds from the beginning) is automatically clipped as the shortened version of a musical piece.

A shortened version of a musical piece is also necessary when a movie (including a slide show) is produced. When a movie with background music (BGM) is produced, generally, a part of a desired musical piece is clipped according to a time necessary to replay an image sequence. Then, the clipped part is added to a movie as BGM.

A technique of automatically generating a shortened version of a musical piece is disclosed in JP 2002-073055A. In the technique disclosed in JP 2002-073055A, in order to decide a part to be clipped from a musical piece, envelope information is acquired by analyzing musical piece data including a speech waveform, and the climax of a musical piece is determined using the acquired envelope information.

### SUMMARY

However, in the technique of clipping a part corresponding to a fixed temporal range from a musical piece, there are many cases in which it fails to include a chorus section expressing the characteristic climax of a musical piece in a shortened version. Further, in the technique of analyzing musical piece data, the accuracy for determining an optimal section for a shortened version is insufficient, and a section that best expresses a feature of a musical piece may not be appropriately extracted.

It is desirable to provide a system capable of extracting a shortened version including a characteristic chorus section with a degree of accuracy higher than that of the above-mentioned existing technique.

According to an embodiment of the present disclosure, there is provided an information processing apparatus, including a data acquiring unit that acquires section data identifying chorus sections among a plurality of sections included in a musical piece, a determining unit that determines a standard chorus section among the chorus sections identified by the section data according to a predefined determination condition for discriminating the standard chorus section from a non-standard chorus section, and a setting unit that sets an extraction range at least partially including the determined standard chorus section to the musical piece.

According to an embodiment of the present disclosure, there is provided an information processing method executed by a control unit of an information processing apparatus, the information processing method including acquiring section data identifying chorus sections among a plurality of sections included in a musical piece, determining a standard chorus section among the chorus sections identified by the section data according to a predefined determination condition for discriminating the standard chorus section from a non-standard chorus section, and setting an extraction range at least partially including the determined standard chorus section to the musical piece.

According to an embodiment of the present disclosure, there is provided a program causing a computer controlling an information processing apparatus to function as a data acquiring unit that acquires section data identifying chorus sections among a plurality of sections included in a musical piece, a determining unit that determines a standard chorus section among the chorus sections identified by the section data according to a predefined determination condition for discriminating the standard chorus section from a non-standard chorus section, and a setting unit that sets an extraction range at least partially including the determined standard chorus section to the musical piece.

According to the embodiments of the present disclosure described above, it is possible to extract a shortened version including a characteristic chorus section with a degree of accuracy higher than that of the existing technique.

### BRIEF DESCRIPTION OF THE DRAWINGS

FIG. 1 is an explanatory diagram for describing a basic principle of the technology according to the present disclosure;

FIG. 2 is a block diagram illustrating an example of a configuration of an information processing apparatus according to an embodiment;

FIG. 3 is an explanatory diagram for describing an example of section data and auxiliary data;

FIG. 4A is a first explanatory diagram for describing a first determination condition for determining a non-standard chorus section;

FIG. 4B is a second explanatory diagram for describing the first determination condition for determining a non-standard chorus section;

FIG. 5 is an explanatory diagram for describing a second determination condition for determining a non-standard chorus section;

FIG. 6 is an explanatory diagram for describing a third determination condition for determining a non-standard chorus section;

FIG. 7 is an explanatory diagram for describing a fourth determination condition for determining a non-standard chorus section;

FIG. 8 is an explanatory diagram for describing a first selection condition for selecting a reference section;

FIG. 9 is an explanatory diagram for describing a second selection condition for selecting a reference section;

FIG. 10 is an explanatory diagram for describing a third selection condition for selecting a reference section;

FIG. 11 is an explanatory diagram for describing a first technique for setting an extraction range;

FIG. 12 is an explanatory diagram for describing a second technique for setting an extraction range;

FIG. 13 is an explanatory diagram for describing an example of an extraction process performed by an extracting unit;

FIG. 14 is a flowchart illustrating an example of a general flow of a process according to an embodiment;

FIG. 15 is a flowchart illustrating an example of a detailed flow of a chorus section filtering process illustrated in FIG. 14;

FIG. 16 is a flowchart illustrating an example of a detailed flow of a reference section selection process illustrated in FIG. 14;

FIG. 17 is a block diagram illustrating an example of a configuration of a server device according to a modified example; and

FIG. 18 is a block diagram illustrating an example of a configuration of a terminal device according to a modified example.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will proceed in the following order.

1. Basic principle

2. Configuration example of information processing apparatus according to embodiment

3. Example of flow of process according to embodiment

4. Modified example

5. Conclusion

### 1. BASIC PRINCIPLE

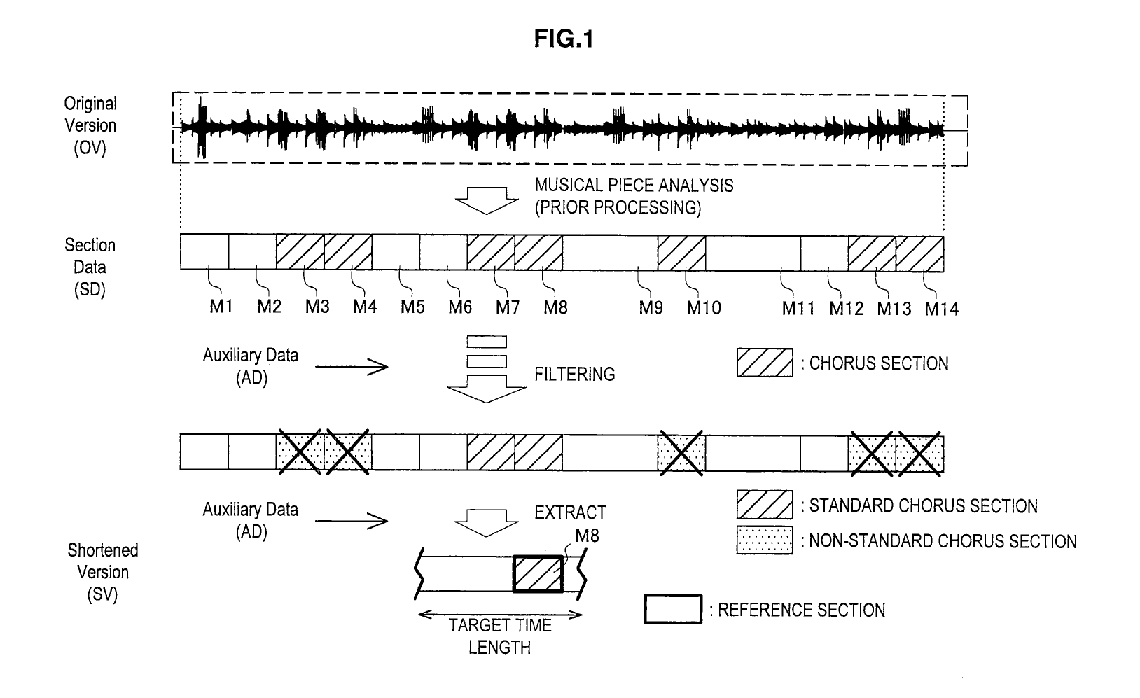

FIG. 1 is an explanatory diagram for describing a basic principle of the technology according to the present disclosure.

Musical piece data OV of a certain musical piece is shown on an upper portion of FIG. 1. For example, the musical piece data OV is data generated such that a waveform of a musical piece according to a time axis is sampled at a predetermined sampling rate, and a sample is encoded. In this disclosure, musical piece data serving as a source from which a shortened version is extracted is also referred to as an “original version.”

Section data SD is shown below the musical piece data OV. The section data SD is data identifying a chorus section among a plurality of sections included in a musical piece. In the example of FIG. 1, among 14 sections M1 to M14 included in the section data SD, 7 sections M3, M4, M7, M8, M10, M13, and M14 are identified as a chorus section. For example, the section data SD is assumed to be given in advance by analyzing the musical piece data OV according to the technique disclosed in JP 2007-156434A (or another existing technique). For example, in the existing technique, a chorus likelihood of each section is derived from a feature quantity by executing audio signal processing on a musical piece and analyzing a waveform thereof. For example, a chorus section may be a section having a chorus likelihood higher than a predetermined threshold value.

Here, it should be noted that a section having the highest chorus likelihood does not necessarily express a feature of a musical piece the best. For example, when a feature quantity based on a power component of a speech waveform is used, a special chorus section, in which an arrangement is added, frequently positioned after the middle of a musical piece is prone to be highest in the chorus likelihood rather than a standard chorus section of a musical piece. Further, when the accuracy of the chorus likelihood is insufficient, a section that is not actually a chorus section may be identified as a chorus section, or a section that is actually a chorus section may not be identified as a chorus section. Further, in a normal vocal musical piece rather than a so-called instrumental musical piece, a non-vocal section having no vocals may be highest in the chorus likelihood.

In this regard, the technology according to the present disclosure uses a qualitative characteristic of a section of a musical piece as well as a result of analyzing a waveform of a musical piece in order to determine a section expressing a feature of a musical piece the best. In the example of FIG. 1, the seven chorus sections M3, M4, M7, M8, M10, M13, and M14 are filtered based on a qualitative characteristic of a chorus section. Then, the two sections M7 and M8 are classified as a standard chorus section, and the remaining sections are classified as non-standard chorus sections. The standard chorus section is a section expressing a feature of a musical piece well. The non-standard chorus section may include, for example, a special chorus section in which an arrangement such as modulation or off-vocal is added, an erroneously identified chorus section (which is not actually a chorus section), or the like. Auxiliary data AD may be additionally used for filtering of a chorus section. One of the standard chorus sections is selected as a reference section. An extraction range (having a length equal to a target time length) is set to a musical piece so that at least a reference section is partially included, and a part of the musical piece data OV corresponding to the extraction range is extracted as a shortened version SV.

According to the above-described principle, since an extraction range of a shortened version is set based on a qualitative characteristic of a chorus section as well as a result of analyzing a musical piece, influence of the instability of the accuracy of musical piece analysis can be reduced, and a shortened version expressing a feature of a musical piece well can be more appropriately generated. An embodiment of the technology according to the present disclosure for implementing this principle will be described in detail in the following section.

### 2. CONFIGURATION EXAMPLE OF INFORMATION PROCESSING APPARATUS ACCORDING TO EMBODIMENT

An information processing apparatus that will be described in this section may be a terminal device such as a personal computer (PC), a smart phone, a personal digital assistant (PDA), a music player, a game terminal, or a digital household electrical appliance. Further, the information processing apparatus may be a server device that executes processing which will be described later according to a request transmitted from the terminal device. The devices may be physically implemented using a single computer or a combination of a plurality of computers.

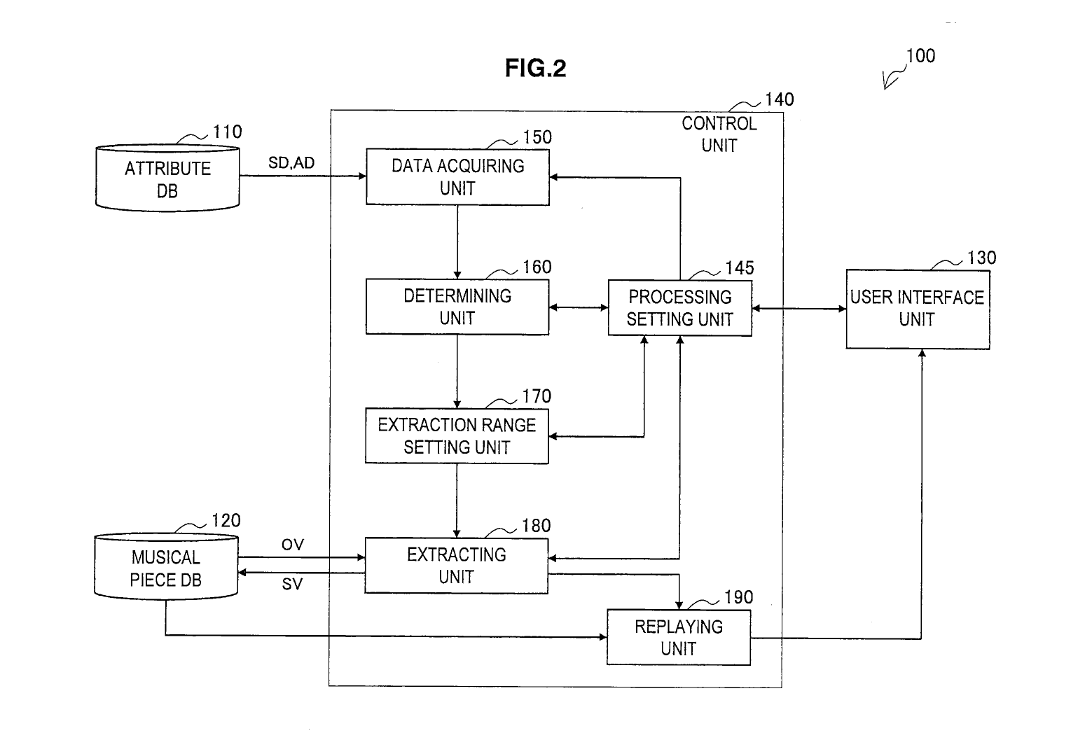

FIG. 2 is a block diagram illustrating an example of a configuration of an information processing apparatus 100 according to the present embodiment. Referring to FIG. 2, the information processing apparatus 100 includes an attribute database (DB) 110, a musical piece DB 120, a user interface unit 130, and a control unit 140.

[2-1. Attribute DB]

The attribute DB 110 is a database configured using a storage medium such as a hard disk or a semiconductor memory. The attribute DB 110 stores attribute data that is prepared on one or more musical pieces in advance. The attribute data may include the section data SD and the auxiliary data AD described with reference to FIG. 1. Section data is data identifying at least a chorus section among a plurality of sections included in a musical piece. Auxiliary data is data that may be additionally used for filtering of a chorus section, selection of a reference section, or setting of an extraction range.

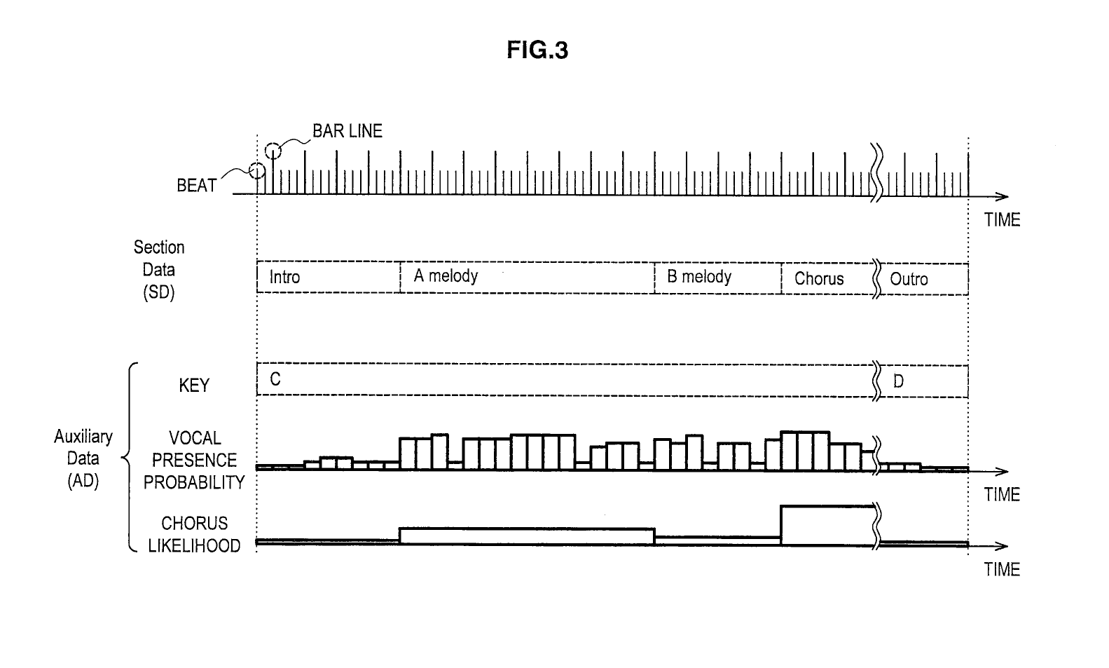

FIG. 3 is an explanatory diagram for describing an example of section data and auxiliary data. A short vertical line placed on a time axis of an upper portion of FIG. 3 represents a temporal position of a beat. A long vertical line represents a temporal position of a bar line. In the section data SD, a melody type such as an Intro, an A melody, a B melody, a chorus, and an outro is identified for each section divided according to a bar line or a beat. The auxiliary data AD includes key data, vocal presence probability data, and chorus likelihood data. For example, the key data identifies a key of each section (for example, “C” represents C major). For example, the vocal presence probability data represents a probability that there will be vocals at each beat position. The chorus likelihood data represents the chorus likelihood calculated for each section. The attribute data may be generated such that audio signal processing is performed on musical piece data according to a technique disclosed in JP 2007-156434A, a technique disclosed in JP 2007-248895A, or a technique disclosed in JP 2010-122629A, and then stored in the attribute DB 110 in advance.

[2-2. Musical Piece DB]

The musical piece DB 120 is also a database configured using a storage medium such as a hard disk or a semiconductor memory. The musical piece DB 120 stores musical piece data of one or more musical pieces. The musical piece data includes waveform data illustrated in FIG. 1. For example, the waveform data may be encoded according to an arbitrary audio coding scheme such as WAVE, MP3 (MPEG Audio Layer-3), or AAC (Advanced Audio Coding). The musical piece DB 120 outputs musical piece data (that is, an original version) OV that is a non-compressed target musical piece to an extracting unit 180 which will be described later. The musical piece DB 120 may additionally store the shortened version SV generated by the extracting unit 180.

Either or both of the attribute DB 110 and the musical piece DB 120 may not be a part of the information processing apparatus 100. For example, the databases may be implemented by a data server accessible by the information processing apparatus 100. Further, a removable medium connected to the information processing apparatus 100 may store the attribute data and the musical piece data.

[2-3. User Interface Unit]

The user interface unit 130 provides the user with a user interface through which the user can have access to the information processing apparatus 100 through the information processing apparatus 100 or the terminal device. Various kinds of user interfaces such as a graphical user interface (GUI), a command line interface, a voice UI, or a gesture UI may be used as the user interface provided by the user interface unit 130. For example, the user interface unit 130 may show a list of musical pieces to the user and cause the user to designate a target musical piece that is a shortened version generation target. Further, the user interface unit 130 may cause the user to designate a target value of a time length of a shortened version, that is, a target time length.

[2-4. Control Unit]

The control unit 140 corresponds to a processor such as a central processing unit (CPU) or a digital signal processor (DSP). The control unit 140 executes a program stored in a storage medium to operate various functions of the information processing apparatus 100. In the present embodiment, the control unit 140 includes a processing setting unit 145, a data acquiring unit 150, a determining unit 160, an extraction range setting unit 170, an extracting unit 180, and a replaying unit 190.

(1) Processing Setting Unit

The processing setting unit 145 sets up processing to be executed by the information processing apparatus 100. For example, the processing setting unit 145 holds various settings such as setting criteria of an identifier of a target musical piece, a target time length, and an extraction range (which will be described later). The processing setting unit 145 may set a musical piece designated by the user as a target musical piece or may automatically set one or more musical pieces whose attribute data is stored in the attribute DB 110 as a target musical piece. The target time length may be designated by the user through the user interface unit 130 or may be automatically set. When the service provider desires to provide many shortened versions for trial listening, the target time length may be set in a uniform manner. Meanwhile, when the user desires to add BGM to a movie, the target time length may be designated by the user. The remaining settings will be further described later.

(2) Data Acquiring Unit

The data acquiring unit 150 acquires the section data SD and the auxiliary data AD of the target musical piece from the attribute DB 110. As described above, in the present embodiment, the section data SD is data identifying at least a chorus section among a plurality of sections included in the target musical piece. Then, the data acquiring unit 150 outputs the acquired section data SD and the auxiliary data AD to the determining unit 160.

(3) Determining Unit

The determining unit 160 determines a standard chorus section expressing a feature of a musical piece well among chorus sections identified by the section data SD according to a predetermined determination condition for distinguishing the standard chorus section from the non-standard chorus section. Here, the determination condition is a condition related to a characteristic of the non-standard chorus section which is common to a plurality of musical pieces. In the present embodiment, the determining unit 160 determines a chorus section that is determined not to be the non-standard chorus section according to the determination condition as the standard chorus section.

For example, at least one of conditions for determining the following four types of non-standard chorus sections may be used as the determination condition.
single chorus section
modulated chorus section
large chorus section
non-vocal section

(3-1) First Determination Condition

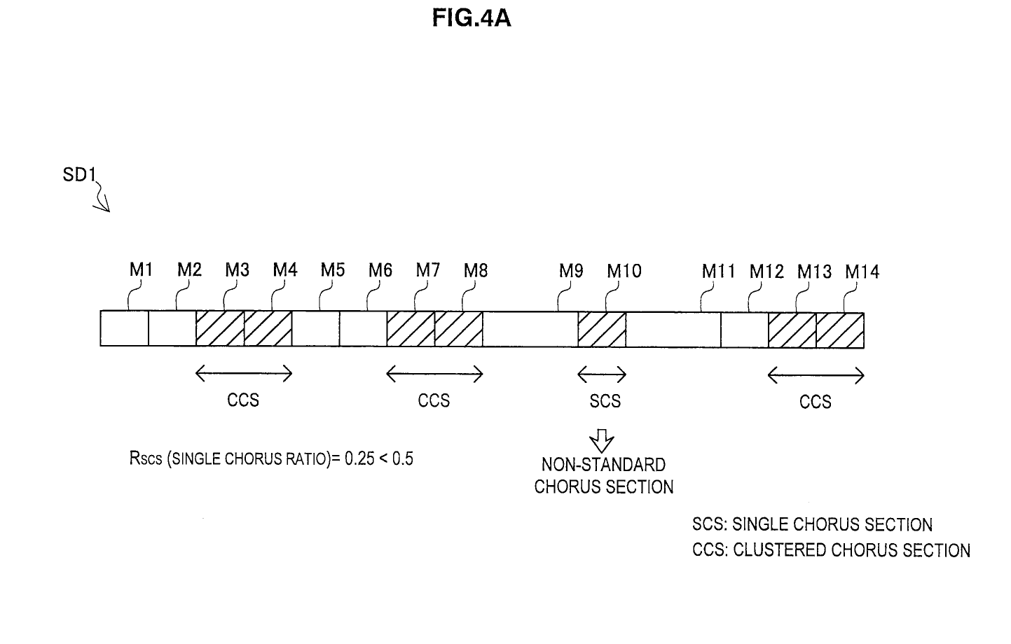

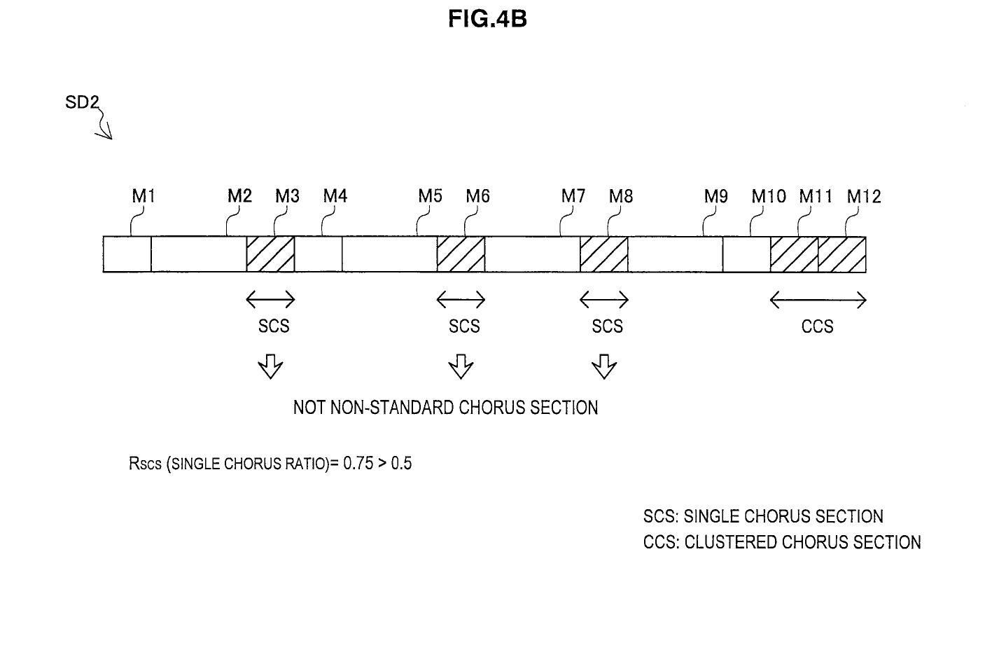

FIGS. 4A and FIG. 4B are explanatory diagrams for describing a first determination condition. The first determination condition is a condition for determining a single chorus section, and is based on whether or not each chorus section is temporally adjacent to another chorus section. In this disclosure, a single chorus section (SCS) means a chorus section that is not temporally adjacent to another chorus section. On the other hand, a cluster of a plurality of chorus sections that are temporally adjacent to each other are referred to as a clustered chorus section (CCS). In a certain musical piece, when the number of single chorus sections is smaller than the number of clustered chorus sections, the single chorus section is likely to be a special chorus section in which an arrangement is added or an erroneously identified chorus section. Thus, in this case, the single chorus section that is the non-standard chorus section is excluded from being a candidate of a reference section (a section dealt with as a reference of a setting of an extraction range), and thus a phenomenon that an inappropriate extraction range is set to a musical piece can be avoided.

Referring to FIG. 4A, the seven chorus sections M3, M4, M7, M8, M10, M13, and M14 identified by section data SD1 are illustrated. The chorus sections M3 and M4 are adjacent to each other, and form a clustered chorus section. The chorus sections M7 and M8 are adjacent to each other, and form a clustered chorus section. The chorus sections M13 and M14 are adjacent to each other, and form a clustered chorus section. The chorus section M10 is a single chorus section that is not adjacent to other chorus sections. The determining unit 160 calculates a single chorus ratio R_{SCS} based on an adjacency relation between chorus sections recognized from the section data. The single chorus ratio R_{SCS} is the ratio of the number of single chorus sections to the total number of single chorus sections and clustered chorus sections. In the example of FIG. 4A, the single chorus ratio R_{SCS} is 0.25 and smaller than 0.5(=0.25<0.5), and the number of single chorus sections is smaller than the number of clustered chorus sections. Thus, the determining unit 160 determines the chorus section M10 that is the single chorus section as the non-standard chorus section.

Referring to FIG. 4B, five chorus sections M3, M6, M8, M11, and M12 identified by section data SD2 are illustrated. The chorus sections M11 and M12 are adjacent to each other, and form a clustered chorus section. None of the chorus section M3, M6, and M8 is adjacent to another chorus section and thus they are single chorus sections. In the example of FIG. 4B, the single chorus ratio R_{SCS} is 0.75 and larger than 0.5(=0.75>0.5), and the number of single chorus sections is larger than the number of clustered chorus sections. Thus, the determining unit 160 determines that the single chorus section is not the non-standard chorus section. In other words, in this case, the single chorus sections M3, M6 and M8 are not excluded from being the reference section candidate but remain.

(3-2) Second Determination Condition

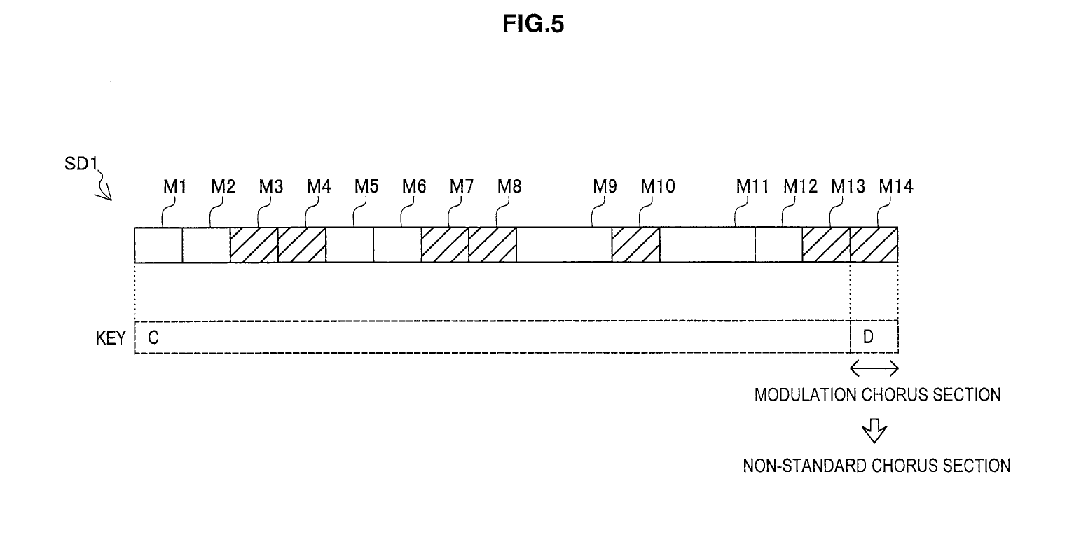

FIG. 5 is an explanatory diagram for describing a second determination condition. The second determination condition is a condition for determining a modulated chorus section, and based on whether or not a key in each chorus section is modulated from a key in another chorus section. In some musical pieces, there are cases in which modulation from a current key to another key (for example, a half tone or a whole tone higher) is performed in the process of a musical piece. The modulated chorus section refers to chorus section for which such modulation is performed. Since the modulated chorus section is a special chorus section in which an arrangement is added, the modulated chorus section is excluded from being the reference section candidate, and thus a phenomenon that an inappropriate extraction range is set to a musical piece can be avoided.

Referring to FIG. 5, the seven chorus sections M3, M4, M7, M8, M10, M13, and M14 identified by the section data SD1 are illustrated again. Further, a key of each section represented by key data that is one of auxiliary data is illustrated. The key data represents that the key from the section M1 to the section M13 is “C (C major),” whereas the key of the section M14 is “D (D major).” Thus, the determining unit 160 determines that the chorus section M14 is the modulation chorus section that is one of the non-standard chorus sections. In some musical pieces, there are cases in which modulation is performed after the middle of the musical piece, and in this case, a modulated chorus is not necessarily a special chorus. In this regard, the determining unit 160 may ignore modulation until a point in time when a predetermined percentage (for example, ⅔) of the entire time length of a musical piece elapses and determine a modulated chorus based on modulation after that point in time.

(3-3) Third Determination Condition

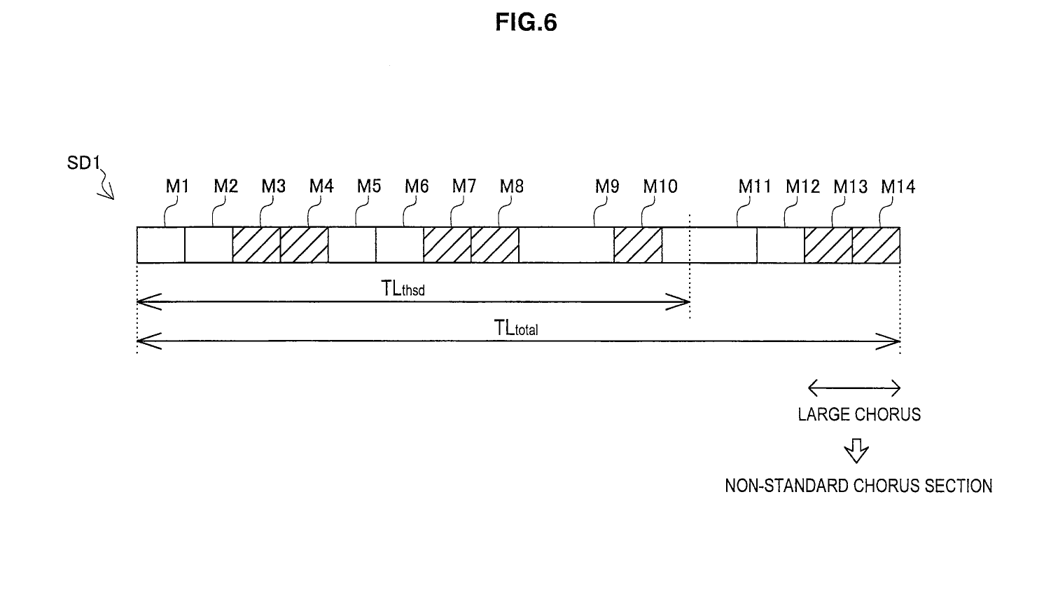

FIG. 6 is an explanatory diagram for describing a third determination condition. The third determination condition is a condition for determining a large chorus section. In many musical pieces, various arrangements such as a change of a melody, a change of a tempo, or a change of lyrics to a specific syllable (“la la . . . ” or the like) is performed in the end of a musical piece. The chorus section in which an arrangement is added does not necessarily express a standard feature of a musical piece well. Thus, the large chorus section is excluded from being the reference section candidate, and a phenomenon that an inappropriate extraction range is set to a musical piece can be avoided. The determining unit 160 may determine that a chorus section present in the end of a musical piece is the large chorus section. For example the end of a musical piece refers to a part after a point in time when a predetermined percentage (for example, ⅔) in the entire time length of a musical piece elapses. Instead, the determining unit 160 may determine that a chorus section or a clustered chorus section positioned most rearward is the large chorus section.

Referring to FIG. 6, the seven chorus sections M3, M4, M7, M8, M10, M13, and M14 identified by the section data SD1 are illustrated again. Further, an entire time length TLₜₒₜₐₗ of a musical piece and a time length TL_{thsd} corresponding to ⅔ of the time length TLₜₒₜₐₗ are illustrated. For example, the determining unit 160 determines that the chorus sections M13 and M14 present after a point in time when the time length TL_{thsd} elapses is the large chorus section that is one of the non-standard chorus sections.

(3-4) Fourth Determination Condition

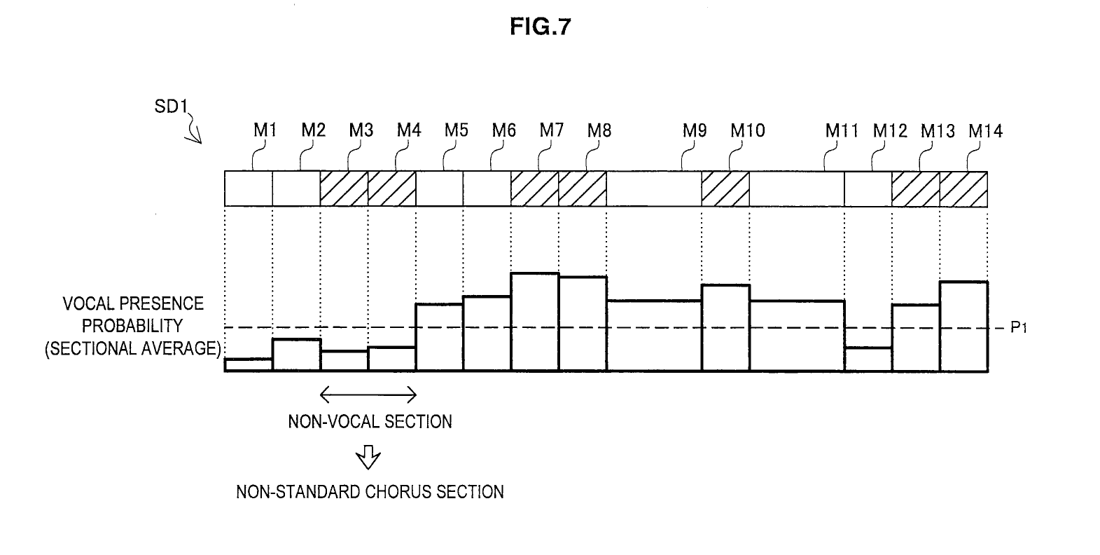

FIG. 7 is an explanatory diagram for describing a fourth determination condition. The fourth determination condition is a condition for determining a non-vocal section. In some vocal musical pieces, there may be a section in which a melody having a chord progression similar to a chorus is played only by a musical instrument. The non-vocal section may be identified as a chorus section as a result of audio signal processing, but a non-vocal section in a vocal musical piece does not necessarily express a standard feature of a musical piece well. Thus, the non-vocal section is excluded from being the reference section candidate, and a phenomenon that an inappropriate extraction range is set to a musical piece can be avoided.

Referring to FIG. 7, the seven chorus sections M3, M4, M7, M8, M10, M13, and M14 identified by the section data SD1 are illustrated again. Further, an average value of respective sections of a probability represented by vocal presence probability data is illustrated. A threshold value P₁ is a threshold value used to identify a non-vocal section. The determining unit 160 determines that the chorus sections M3 and M4 in which a sectional average of the vocal presence probability is lower than the threshold value P₁ are the non-vocal section that is one of the non-standard chorus sections.

The determining unit 160 may dynamically decide the threshold value P₁ according to the vocal presence probability throughout a musical piece. For example, the threshold value P₁ may be an average value of the vocal presence probability in the entire musical piece or a product of the average value and a predetermined coefficient. The threshold value to be compared with the sectional average of the vocal presence probability is dynamically decided as described above, and thus, for example, in an instrumental musical piece in which there are generally no vocals, a section expressing a feature of a musical piece well can be prevented from being excluded from being the reference section candidate.

The determining unit 160 sets one or more chorus sections identified by the section data SD as a reference section candidate set, and removes a non-standard chorus section determined as the non-standard chorus section according to at least one of the determination conditions from the reference section candidate set. A chorus section remaining in the reference section candidate set is determined as a standard chorus section expressing a feature of a musical piece well. Then, the determining unit 160 outputs the reference section candidate set to the extraction range setting unit 170.

(4) Extraction Range Setting Unit

The extraction range setting unit 170 acquires the reference section candidate set from the determining unit 160. Here, the acquired reference section candidate set includes the standard chorus sections and not the non-standard chorus sections. The extraction range setting unit 170 selects the reference section from the acquired reference section candidate set. The extraction range setting unit 170 sets an extraction range at least partially including the selected reference section to a target musical piece.

(4-1) Selection of Reference Section

For example, the extraction range setting unit 170 may select a section having the highest chorus likelihood represented by the chorus likelihood data as the reference section (a first selection condition). Instead, the extraction range setting unit 170 may select a section having the highest sectional average of the vocal presence probability as the reference section (a second selection condition). Further, when the reference section candidate set is empty, that is, when there is no section determined as the standard chorus section, the extraction range setting unit 170 may select a section having the highest vocal presence probability among sections included in the target musical piece rather than the chorus section as the reference section (a third selection condition).

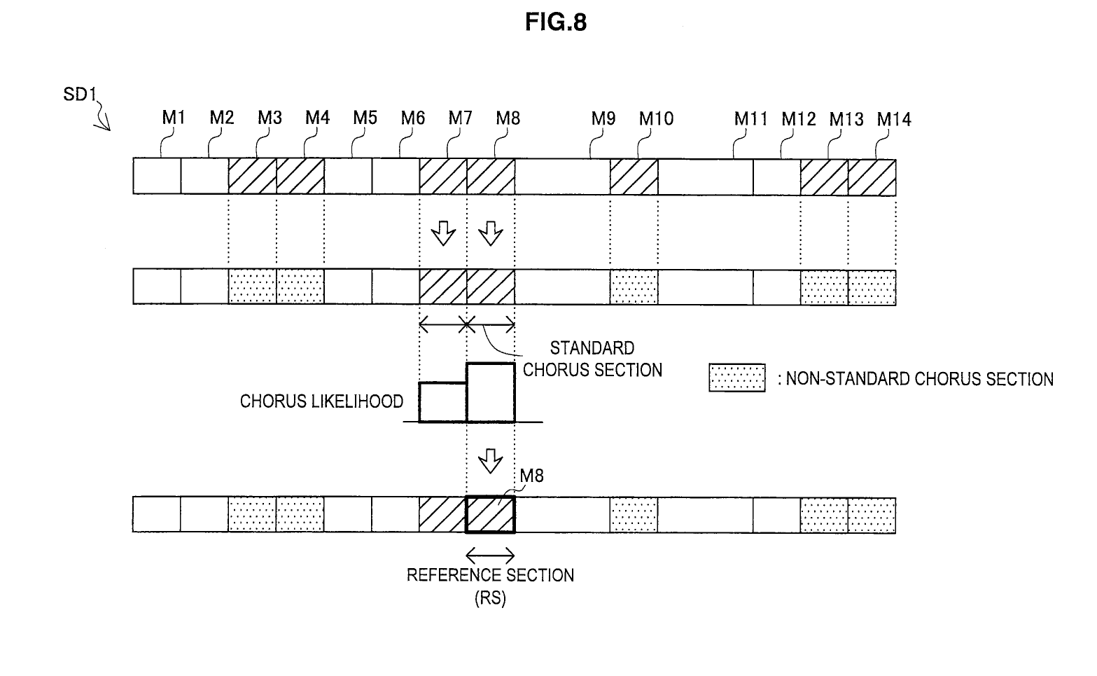

FIG. 8 is an explanatory diagram for describing the first selection condition for selecting the reference section. Referring to FIG. 8, among the seven chorus sections M3, M4, M7, M8, M10, M13, and M14 identified by the section data SD1, the sections M7 and M8 are determined as the standard chorus section. The chorus likelihood of the standard chorus section M8 is higher than the chorus likelihood of the standard chorus section M7. In this regard, the extraction range setting unit 170 may select the standard chorus section M8 as the reference section (RS). A technique of selecting the reference section based on the chorus likelihood is similar to the existing technique based on only a result of analyzing a musical piece in certain aspects. However, in the present embodiment, a chorus section determined as the non-standard chorus section based on a qualitative characteristic of a chorus section common to a plurality of musical pieces is excluded from the reference section candidate set. Thus, a special chorus section that does not express a feature of a musical piece well but shows high chorus likelihood can be prevented from being selected as a reference of a setting of an extraction range.

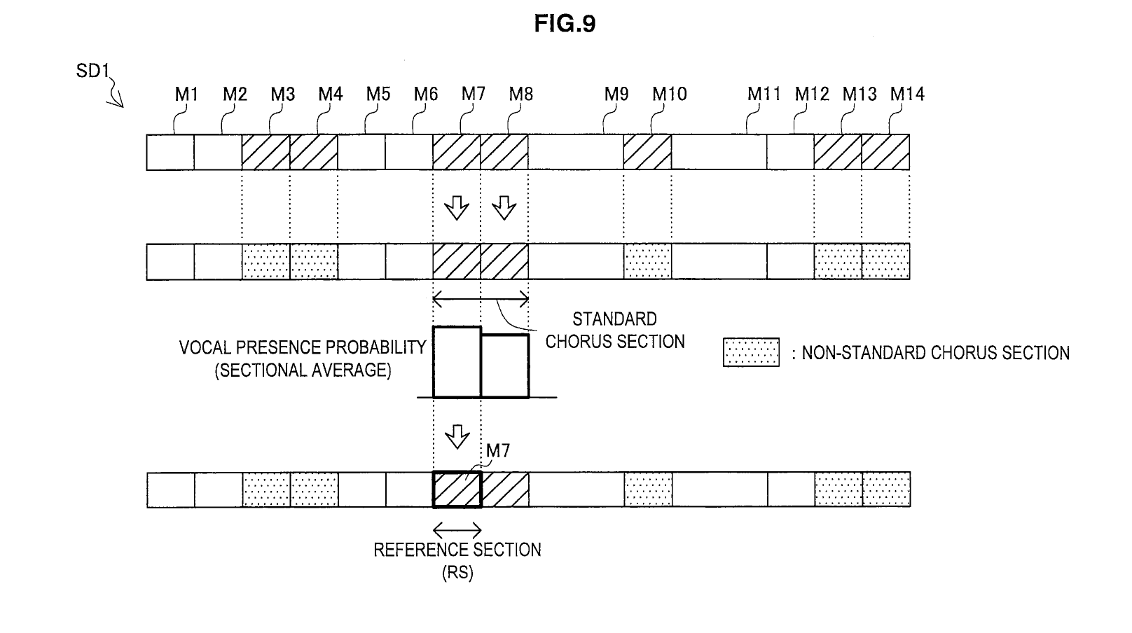

FIG. 9 is an explanatory diagram for describing the second selection condition for selecting the reference section. Referring to FIG. 9, similarly to the example of FIG. 8, among the seven chorus sections M3, M4, M7, M8, M10, M13, and M14 identified by the section data SD1, the sections M7 and M8 are determined as the standard chorus section. The vocal presence probability (the sectional average) of the standard chorus section M7 is higher than the vocal presence probability of the standard chorus section M8. In this regard, the extraction range setting unit 170 may select the standard chorus section M7 as the reference section. According to the technique of selecting the reference section based on the vocal presence probability, a chorus section which is a vocal section expressing a feature of a musical piece well can be more reliably included in an extraction range for a shortened version. The extraction range setting unit 170 may employ the second selection condition unless a target musical piece is an instrumental musical piece.

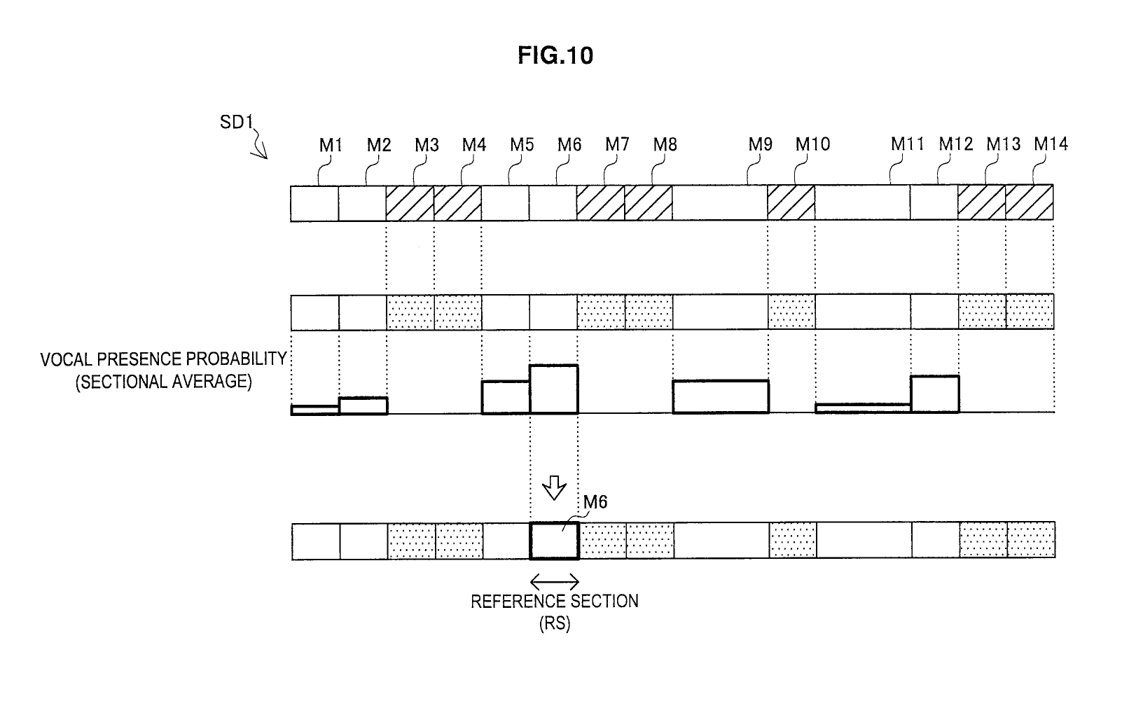

FIG. 10 is an explanatory diagram for describing the third selection condition for selecting the reference section. In the example of FIG. 10, all of the seven chorus section M3, M4, M7, M8, M10, M13 and M14 are determined as non-standard chorus sections, and thus there is no standard chorus section. In this case, the extraction range setting unit 170 compares the vocal presence probabilities (the sectional averages) of the sections that are not chorus sections with each other. Then, the extraction range setting unit 170 may select the section (the section M6 in the example of FIG. 10) having the highest vocal presence probability as the reference section. For example, when the accuracy of the chorus likelihood obtained as a result of analyzing a musical piece is bad or when a target musical piece has an exceptional melody configuration, the standard chorus section is unlikely to remain in the reference section candidate set. Even in this case, when the reference selection is selected according to the third selection condition, a vocal section expressing a feature of a musical piece relatively well can be included in an extraction range for a shortened version.

Further, when neither the chorus likelihood data nor the vocal presence probability data is available, the extraction range setting unit 170 may select a section at a predetermined position (for example, the front part) or a randomly selected section among the standard chorus sections remaining in the reference section candidate set as the reference section.

(4-2) Setting of Extraction Range

After selecting the reference section using any of the above-described selection conditions, the extraction range setting unit 170 sets an extraction range at least partially including the selected reference section to a target musical piece. For example, the extraction range setting unit 170 may set a vocal absence point in time ahead of the reference section as a starting point of the extraction range. The vocal absence point in time refers to a point in time when the vocal presence probability (a probability of each beat position having a high temporal resolution rather than the sectional average) represented by the vocal presence probability data dips below a predetermined threshold value. As the vocal absence point in time ahead of the beginning of the reference section is set as the starting point of the extraction range, even when a singer utters lyrics of the reference section earlier than the beginning of the reference section, omission of lyrics in the shortened version can be avoided. Further, the extraction range setting unit 170 sets a point in time far from the starting point of the extraction range rearward by the target time length as an ending point of the extraction range.

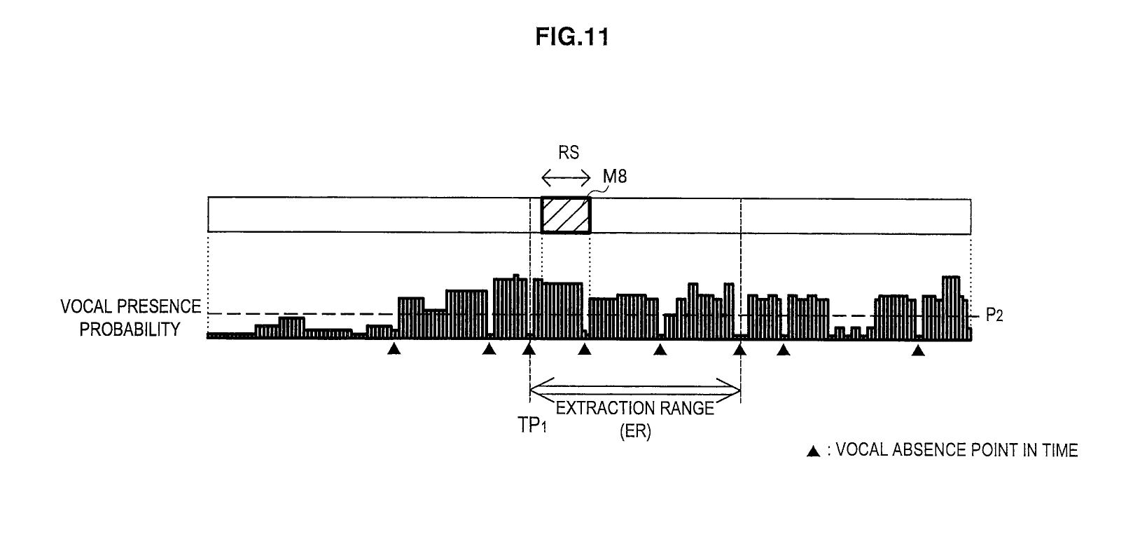

For example, the extraction range setting unit 170 may set a vocal absence point in time that is ahead of and closest to the reference section as the starting point of the extraction range. FIG. 11 is an explanatory diagram for describing a first technique of setting the extraction range. Referring to FIG. 11, the standard chorus section M8 selected as the reference section and the vocal presence probability of each beat position are illustrated. Triangular symbols in FIG. 11 indicate several vocal absence points in time (points in time when the vocal presence probability is lower than the threshold value P₂) in the vocal section. In the example of FIG. 11, the extraction range setting unit 170 sets a vocal absence point in time TP₁ ahead of the reference section M8 as a starting point, and sets an extraction range (ER) having the length corresponding to the target time length as the target musical piece. According to the first technique, for example, when a shortened version for trial listening is used in a musical piece delivery service, the user listens to a section that best expresses a feature of a musical piece at an earlier timing, and thus it is possible to efficiently encourage the user to purchase the musical piece.

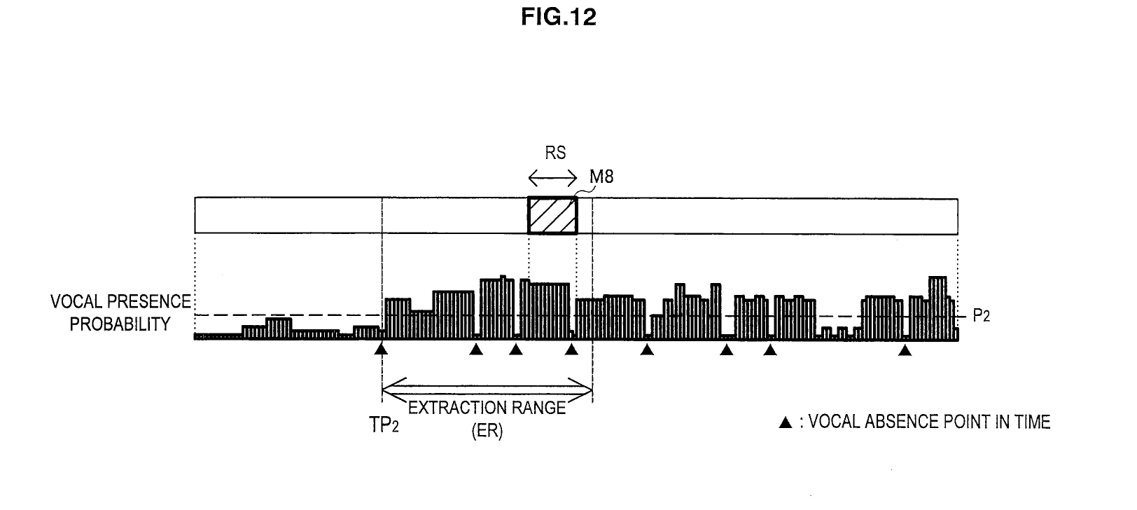

Instead, for example, when the target time length of the extraction range is longer than the target time length of the reference section, the extraction range setting unit 170 may select a vocal absence point in time to be set as the starting point of the extraction range such that the reference section is included further rearward in the extraction range. FIG. 12 is an explanatory diagram for describing a second technique of setting the extraction range. In the example of FIG. 12, a vocal absence point in time TP₂ positioned ahead of the vocal absence point in time TP₁ illustrated in FIG. 11 is selected as the starting point of the extraction range. As a result, the reference section M8 is included further rearward in the set extraction range. According to the second technique, for example, when a shortened version is generated for BGM of a movie having the climax in the rear, a chorus section that best expresses a feature of a musical piece can be arranged in time with the climax.

For example, the extraction range setting unit 170 may cause the user to designate a setting criterion (for example, the first technique or the second technique) related to the position at which the starting point of the extraction range is set through the user interface unit 130. Thus, an appropriate extraction range can be set to a musical piece according to various purposes of a shortened version. When the target time length of the extraction range is smaller than the target time length of the reference section, a part of the reference section may be included in the extraction range.

(5) Extracting Unit

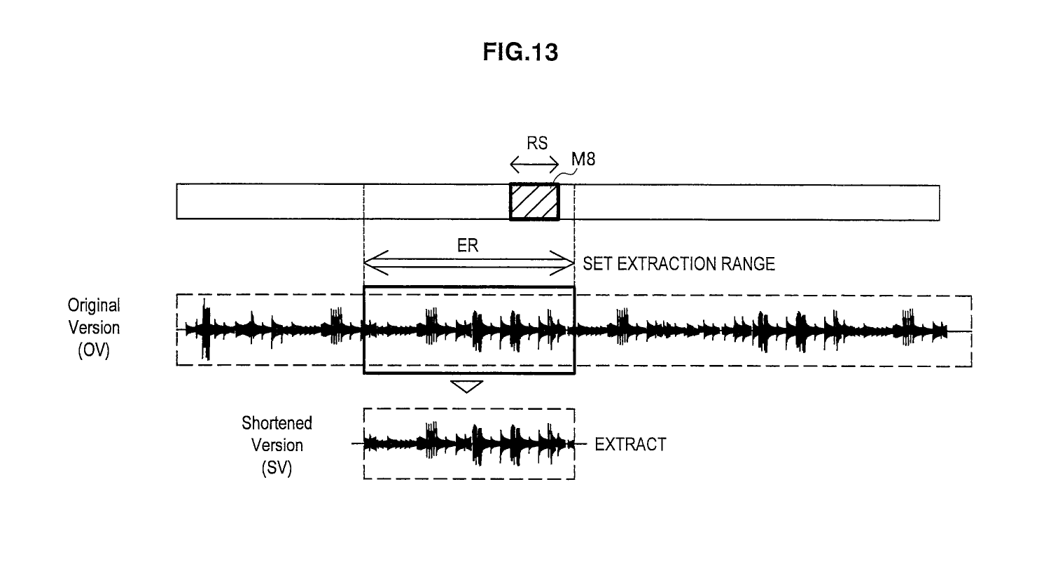

The extracting unit 180 extracts a part corresponding to the extraction range set by the extraction range setting unit 170 from musical piece data of a target musical piece, and generates a shortened version of the target musical piece. FIG. 13 is an explanatory diagram for describing an example of an extraction process by the extracting unit 180. Referring to FIG. 13, the standard chorus section M8 selected as the reference section and the extraction range ER set to include the standard chorus section M8 are illustrated. The extracting unit 180 extracts a part corresponding to the extraction range ER from the musical piece data OV of the target musical piece acquired from the musical piece DB 120. As a result, the shortened version SV of the target musical piece is generated. The extracting unit 180 may fade out the end of the shortened version SV. The extracting unit 180 causes the generated shortened version SV to be stored in the musical piece DB 120. Instead, the extracting unit 180 may output the shortened version SV to the replaying unit 190 and cause the shortened version SV to be replayed by the replaying unit 190. For example, the shortened version SV may be replayed by the replaying unit 190 for trial listening or added to a movie as BGM.

(6) Replaying Unit

The replaying unit 190 replays a musical piece generated by the extracting unit 180. For example, the replaying unit 190 replays the shortened version SV acquired from the musical piece DB 120 or the extracting unit 180, and outputs a sound of a reduced musical piece through the user interface unit 130.

### 3. EXAMPLE OF FLOW OF PROCESS ACCORDING TO EMBODIMENT

[3-1. General Flow]

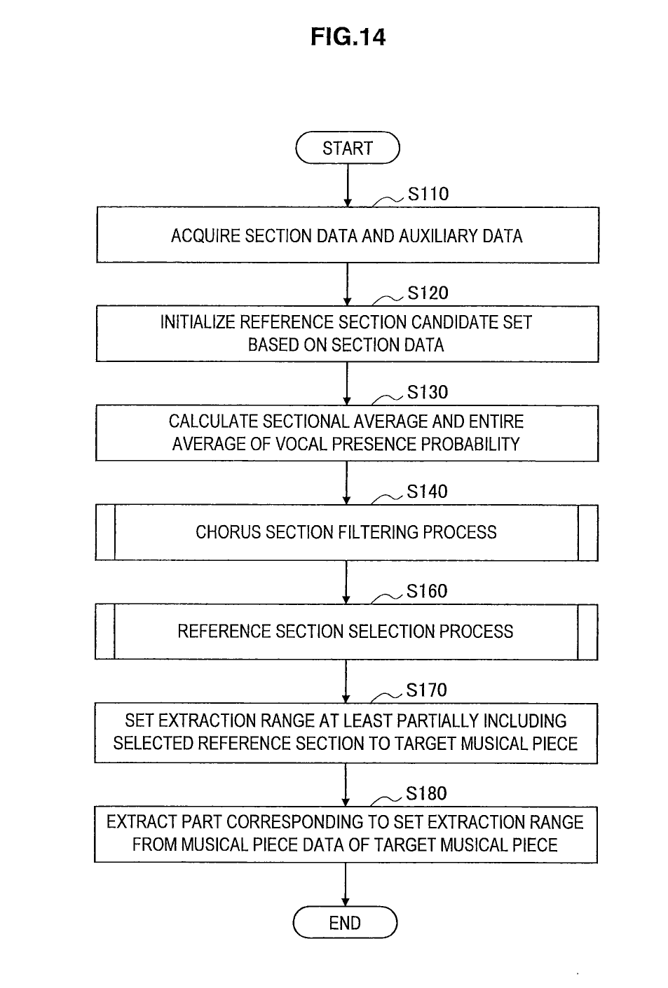

FIG. 14 is a flowchart illustrating an example of a general flow of a process executed by the information processing apparatus 100 according to the present embodiment.

Referring to FIG. 14, first of all, the data acquiring unit 150 acquires section data and auxiliary data of a target musical piece from the attribute DB 110 (step S110). Then, the data acquiring unit 150 outputs the acquired section data and auxiliary data to the determining unit 160.

Next, the determining unit 160 initializes the reference section candidate set based on the section data input from the data acquiring unit 150 (step S120). For example, the determining unit 160 prepares a bit array having a length equal to the number of sections included in the target musical piece, and sets a bit corresponding to a chorus section identified by the section data to “1” and sets the remaining bits to “0.”

Next, the determining unit 160 calculates the sectional average of the vocal presence probability represented by the vocal presence probability data of the target musical piece on each section. Further, the determining unit 160 calculates an average of the vocal presence probability for the whole musical piece (step S130).

Next, the determining unit 160 executes a chorus section filtering process (step S140). The chorus section filtering process to be executed here will be described later in detail. A section determined as the non-standard chorus section in the chorus section filtering process is excluded from the reference section candidate set. In other words, for example, the bit corresponding to the non-standard chorus section in the bit array prepared in step S120 is changed to “0.”

Next, the extraction range setting unit 170 executes a reference section selection process (step S160). The reference section selection process to be executed here will be described later in detail. As a result of the reference section selection process, any one of standard chorus section corresponding to the bit representing “1” in the bit array (or another section) is selected as the reference section. Next, the extraction range setting unit 170 sets the extraction range at least partially including the selected reference section to the target musical piece, for example, according to the first technique or the second technique (step S170).

Next, the extracting unit 180 extracts a part corresponding to the extraction range set by the extraction range setting unit 170 from the musical piece data of the target musical piece (step S180). As a result, a shortened version of the target musical piece is generated. Then, the extracting unit 180 outputs the generated shortened version to the musical piece DB 120 or the replaying unit 190.

[3-2. Chorus Section Filtering Process]

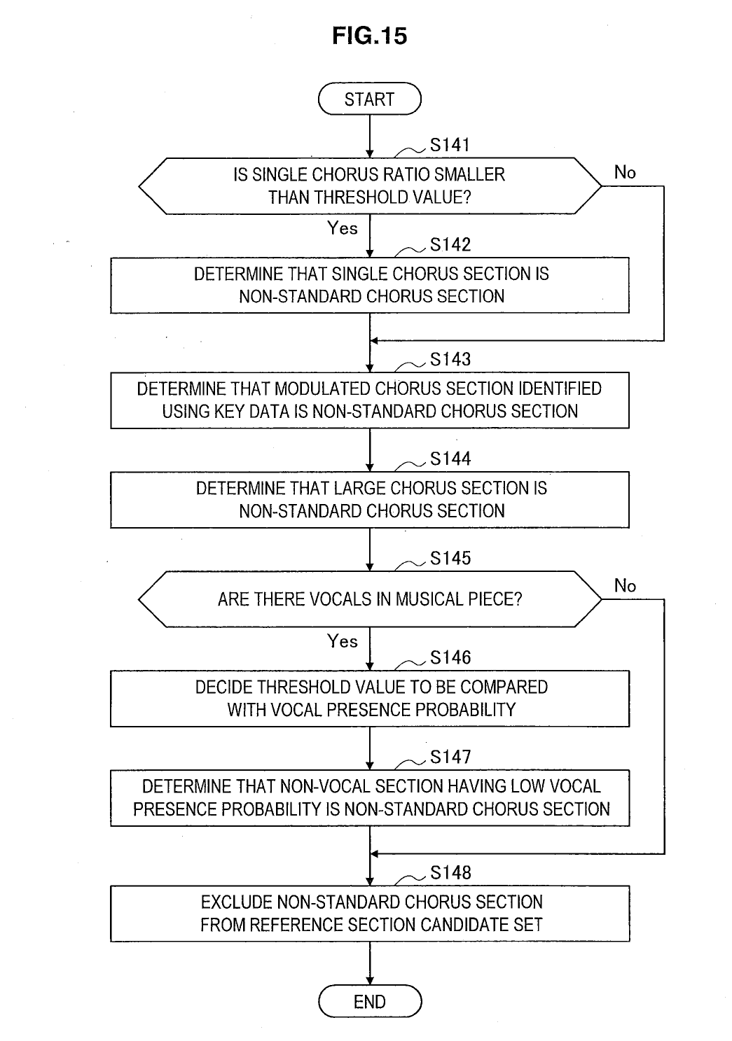

FIG. 15 is a flowchart illustrating an example of a detailed flow of the chorus section filtering process illustrated in FIG. 14.

Referring to FIG. 15, first of all, the determining unit 160 counts the single chorus sections and the clustered chorus sections included in the target musical piece, and determines whether or not the single chorus ratio of the target musical piece is smaller than a threshold value (for example, 0.5) (step S141). Then, the determining unit 160 determines that a single chorus section is a non-standard chorus section when the single chorus ratio of the target musical piece is smaller than the threshold value (step S142).

Next, the determining unit 160 identifies a modulated chorus section included in the target musical piece using key data, and determines that the identified modulated chorus section is a non-standard chorus section (step S143).

Next, the determining unit 160 identifies a large chorus section included in the target musical piece based on a temporal position of each chorus section, and determines that the identified large chorus section is a non-standard chorus section (step S144).

Next, the determining unit 160 determines whether or not there are vocals in the target musical piece (step S145). This determination may be performed based on the vocal presence probability of the target musical piece or based on the type (a vocal musical piece, an instrumental musical piece, or the like) allocated to a musical piece in advance. When it is determined that there are vocals in the target musical piece, the determining unit 160 decides a threshold value (the threshold value P₁ illustrated in FIG. 7) to be compared with the vocal presence probability from the average value of the vocal presence probability throughout the musical pieces (step S146). Then, the determining unit 160 determines that the non-vocal section in which the sectional average of the vocal presence probability is lower than the threshold value decided in step S146 is a non-standard chorus section (step S147).

Then, the determining unit 160 excludes the chorus section determined as the non-standard chorus section in steps S142, S143, S144, and S147 from the reference section candidate set (step S148). For example, the determining unit 160 changes the bit corresponding to the non-standard chorus section in the bit array prepared in step S120 of FIGS. 14 to “0.” Here, the chorus sections (the sections corresponding to the bits representing “1” in the bit array) that are not excluded but remain are the standard chorus sections.

[3-3. Chorus Section Filtering Process]

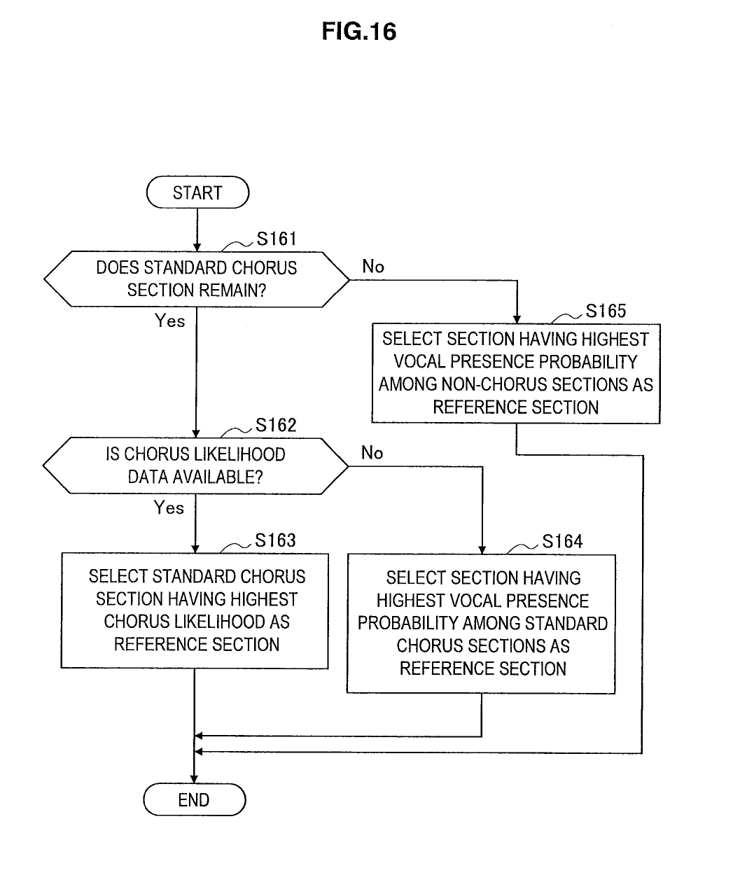

FIG. 16 is a flowchart illustrating an example of a detailed flow of the reference section selection process illustrated in FIG. 14.

Referring to FIG. 16, first of all, the extraction range setting unit 170 determines whether a standard chorus section remains in the reference section candidate set (step S161). Here, when it is determined that a standard chorus section remains in the reference section candidate set, the process proceeds to step 5162. However, when it is determined that no standard chorus section remains in the reference section candidate set (for example, all bits in the bit array represent “0”), the process proceeds to step S165.

In step S162, the extraction range setting unit 170 determines whether or not chorus likelihood data is available (step S162). Here, when it is determined that chorus likelihood data is available, the process proceeds to step S163. However, when it is determined that chorus likelihood data is not available, the process proceeds to step S164.

In step S163, the extraction range setting unit 170 selects a section having the highest chorus likelihood among standard chorus sections remaining in the reference section candidate set as the reference section (step S163).

In step S164, the extraction range setting unit 170 selects a section that is highest in the sectional average of the vocal presence probability among standard chorus sections remaining in the reference section candidate set as the reference section (step S164).

In step S165, the extraction range setting unit 170 selects a section having the highest vocal presence probability among sections other than the chorus sections as the reference section (step S165).

The flow of the process described in this section is merely an example. In other words, some steps of the above-described process may be omitted, or other process steps may be added. Further, the order of the process may be changed, or several process steps may be executed in parallel.

### 4. MODIFIED EXAMPLE

In the technology according to the present disclosure, the device setting the extraction range to the target musical piece using the section data and the device extracting the shortened version of the target musical piece from the musical piece data are not necessarily the same device. In this section, a modified example will be described in connection with an example in which the extraction range is set to the target musical piece in the server device, and the extraction process is executed in the terminal device communicating with the server device.

[4-1. Server Device]

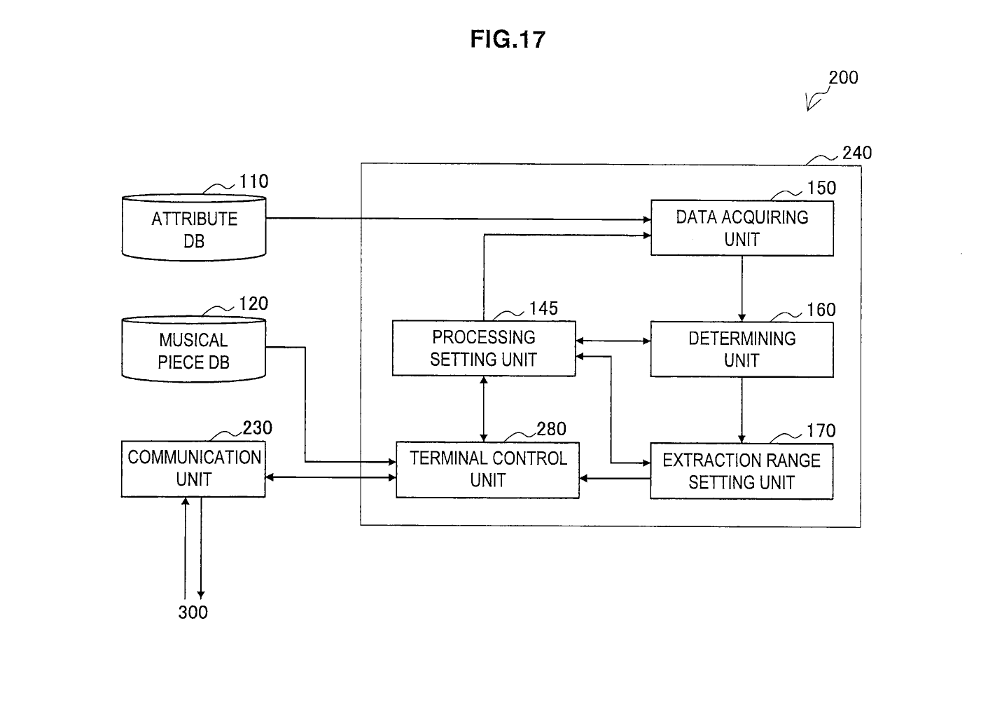

FIG. 17 is a block diagram illustrating an example of a configuration of a server device 200 according to a modified example. Referring to FIG. 17, the server device 200 includes an attribute DB 110, a musical piece DB 120, a communication unit 230, and a control unit 240. The control unit 240 includes a processing setting unit 145, a data acquiring unit 150, a determining unit 160, an extraction range setting unit 170, and a terminal control unit 280.

The communication unit 230 is a communication interface that performs communication with a terminal device 300 which will be described later.

The terminal control unit 280 causes the processing setting unit 145 to set a target musical piece according to a request from the terminal device 300, and causes the determining unit 160 and the extraction range setting unit 170 to execute the above-described process. As a result, an extraction range including a reference section expressing a feature of a target musical piece well is set to a target musical piece through the extraction range setting unit 170. Further, the terminal control unit 280 transmits extraction range data specifying the set extraction range to the terminal device 300 through the communication unit 230. For example, the extraction range data may be data identifying a starting point and an ending point of a range to be extracted from musical piece data. When the terminal device 300 does not have the musical piece data of the target musical piece, the terminal control unit 280 may transmit the musical piece data acquired from the musical piece DB 120 to the terminal device 300 through the communication unit 230.

[4-2. Terminal Device]

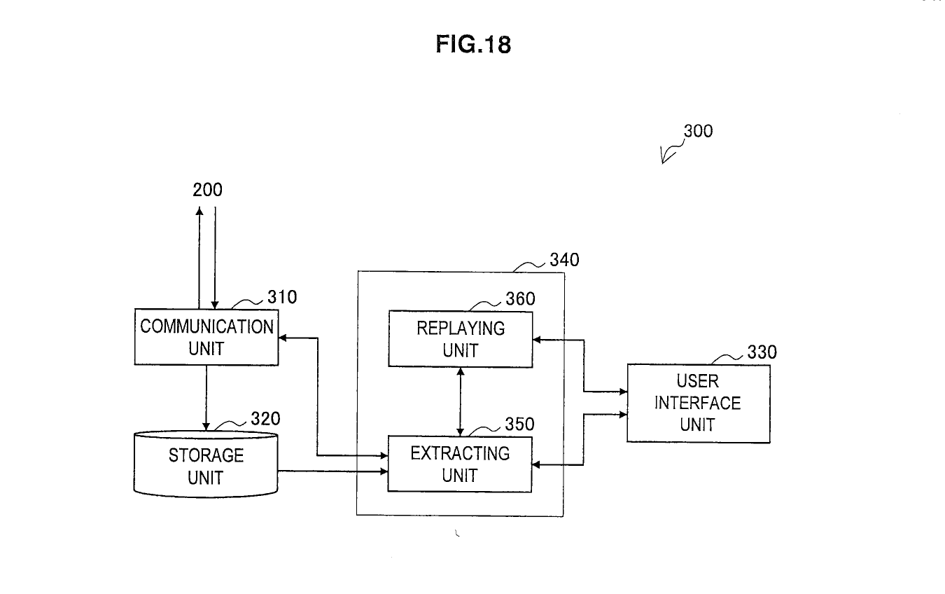

FIG. 18 is a block diagram illustrating an example of a configuration of the terminal device 300 according to the modified example. Referring to FIG. 18, the terminal device 300 includes a communication unit 310, a storage unit 320, a user interface unit 330, and a control unit 340. The control unit 340 includes an extracting unit 350 and a replaying unit 360.

The communication unit 310 is a communication interface communicating with the server device 200. The communication unit 310 receives the extraction range data and the musical piece data as necessary from the server device 200.

The storage unit 320 stores data received by the communication unit 310. The storage unit 320 may store the musical piece data in advance.

The user interface unit 330 provides the user using the terminal device 300 with a user interface. For example, the user interface provided by the user interface unit 330 may include a GUI causing the user to designate a target musical piece and a target time length.

The extracting unit 350 requests the server device 200 to transmit the extraction range data used to extract the shortened version of the target musical piece according to an instruction from the user input through the user interface unit 330. Further, upon receiving the extraction range data from the server device 200, the extracting unit 350 extracts the shortened version. More specifically, the extracting unit 350 acquires the musical piece data of the target musical piece from the storage unit 320. Further, the extracting unit 350 extracts a part corresponding to the extraction range specified by the extraction range data from the musical piece data, and generates the shortened version of the target musical piece. The shortened version of the target musical piece generated by the extracting unit 350 is output to the replaying unit 360.

The replaying unit 360 acquires the shortened version of the target musical piece from the extracting unit 350, and replays the acquired shortened version.

### 5. CONCLUSION

The embodiments of the technology according to the present disclosure and the modified example thereof have been described in detail so far. According to the above embodiments, it is determined whether or not each chorus section included in a musical piece is any one of a standard chorus section and a non-standard chorus section according to a predetermined determination condition, and an extraction range at least partially including a standard chorus section is set to a corresponding musical piece in order to extract a shortened version. Thus, compared to the existing technique of setting an extraction range for a shortened version to a musical piece based on only a result of analyzing a waveform of a musical piece, a shortened version including a characteristic chorus section can be extracted with a high degree of accuracy.

Further, according to the above embodiment, the determination condition is defined based on a qualitative characteristic of a non-standard chorus section common to a plurality of musical pieces. Thus, a phenomenon that an extraction range is set to a musical piece based on a special chorus section that does not express a standard feature of a musical piece can be efficiently avoided.

Further, according to the technology according to the present disclosure, a shortened version including a chorus section expressing a feature of a musical piece well can be automatically generated without requiring additional audio signal processing for analyzing a waveform of a musical piece. Thus, for a large number of musical pieces dealt with in a musical piece delivery service, shortened versions for trial listening encouraging the user's buying motivation can be rapidly provided at a low cost. Further, an optimal shortened version can be automatically generated as BGM of a movie including a slide show.

A series of control process by each device described in this disclosure may be implemented using software, hardware, or a combination of software and hardware. For example a program configuring software is stored in a storage medium installed inside or outside each device in advance. Further, for example, each program is read to a random access memory (RAM) at the time of execution and then executed by a processor such as a CPU.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.
(1) An information processing apparatus, including:

a data acquiring unit that acquires section data identifying chorus sections among a plurality of sections included in a musical piece;

a determining unit that determines a standard chorus section among the chorus sections identified by the section data according to a predefined determination condition for discriminating the standard chorus section from a non-standard chorus section; and

a setting unit that sets an extraction range at least partially including the determined standard chorus section to the musical piece.
(2) The information processing apparatus according to (1),

wherein the determination condition is a condition related to a characteristic of the non-standard chorus section common to a plurality of musical pieces, and

wherein the determining unit determines that a chorus section that is determined not to be the non-standard chorus section according to the determination condition is the standard chorus section.
(3) The information processing apparatus according to (2),

wherein the determining unit determines whether or not each chorus section is the non-standard chorus section based on whether or not each chorus section is temporally adjacent to another chorus section.
(4) The information processing apparatus according to (2) or (3),

wherein the determining unit determines whether or not each chorus section is the non-standard chorus section based on whether or not a key in each chorus section is modulated from a key in another chorus section.
(5) The information processing apparatus according to any one of (2) to (4),

wherein the determining unit determines that a chorus section corresponding to a large chorus present at an end part of the musical piece is the non-standard chorus section.
(6) The information processing apparatus according to any one of (2) to (5),

wherein the determining unit determines whether or not each chorus section is the non-standard chorus section based on a vocal presence probability in each chorus section.
(7) The information processing apparatus according to (6),

wherein the determining unit compares the vocal presence probability in each chorus section with a threshold value dynamically decided according to a vocal presence probability throughout the musical piece, and determines whether or not each chorus section is the non-standard chorus section.
(8) The information processing apparatus according to any one of (1) to (7),

wherein the setting unit selects one of the standard chorus sections determined by the determining unit as a reference section, and sets the extraction range to the musical piece such that the selected reference section is at least partially included in the extraction range.
(9) The information processing apparatus according to (8),

wherein the data acquiring unit further acquires chorus likelihood data representing a chorus likelihood of each of the plurality of sections calculated by executing audio signal processing on the musical piece, and

wherein the setting unit selects, as the reference section, a section that is highest in the chorus likelihood represented by the chorus likelihood data among the standard chorus sections determined by the determining unit.
(10) The information processing apparatus according to (8),

wherein the setting unit selects, as the reference section, a section that is highest in a vocal presence probability among the standard chorus sections determined by the determining unit.
(11) The information processing apparatus according to (9) or (10),

wherein, when there is no section that is determined as the standard chorus section by the determining unit, the setting unit selects, as the reference section, a section that is highest in a vocal presence probability among sections included in the musical piece other than a chorus section.
(12) The information processing apparatus according to any one of (8) to (11),

wherein the setting unit sets a vocal absence point in time ahead of the selected reference section as a starting point of the extraction range.
(13) The information processing apparatus according to (12),

wherein the setting unit sets the vocal absence point in time closest to the reference section as the starting point of the extraction range.
(14) The information processing apparatus according to (12),

wherein, when a time length of the extraction range is longer than a time length of the reference section, the setting unit sets, as the starting point of the extraction range, the vocal absence point in time selected such that the reference section is included further rearward in the extraction range.
(15) The information processing apparatus according to any one of (1) to (14), further including

an extracting unit that extracts a part corresponding to the extraction range set by the setting unit from the musical piece.
(16) The information processing apparatus according to any one of (1) to (14), further including

a communication unit that transmits extraction range data specifying the extraction range to a device that extracts a part corresponding to the extraction range set by the setting unit from the musical piece.
(17) An information processing method executed by a control unit of an information processing apparatus, the information processing method including:

acquiring section data identifying chorus sections among a plurality of sections included in a musical piece;

determining a standard chorus section among the chorus sections identified by the section data according to a predefined determination condition for discriminating the standard chorus section from a non-standard chorus section; and

setting an extraction range at least partially including the determined standard chorus section to the musical piece.
(18) A program for causing a computer controlling an information processing apparatus to function as:

a data acquiring unit that acquires section data identifying chorus sections among a plurality of sections included in a musical piece;

a determining unit that determines a standard chorus section among the chorus sections identified by the section data according to a predefined determination condition for discriminating the standard chorus section from a non-standard chorus section; and

a setting unit that sets an extraction range at least partially including the determined standard chorus section to the musical piece.

The present disclosure contains subject matter related to that disclosed in Japanese Priority Patent Application JP 2012-143954 filed in the Japan Patent Office on Jun. 27, 2012, the entire content of which is hereby incorporated by reference.

What is claimed is:

1. An information processing apparatus, comprising:
a data acquiring unit that acquires section data identifying chorus sections among a plurality of sections included in a musical piece;
a determining unit that determines a standard chorus section among the chorus sections identified by the section data according to a predefined determination condition for discriminating the standard chorus section from a non-standard chorus section; and
a setting unit that sets an extraction range at least partially including the determined standard chorus section to the musical piece.

2. The information processing apparatus according to claim 1,
wherein the determination condition is a condition related to a characteristic of the non-standard chorus section common to a plurality of musical pieces, and
wherein the determining unit determines that a chorus section that is determined not to be the non-standard chorus section according to the determination condition is the standard chorus section.

3. The information processing apparatus according to claim 2,
wherein the determining unit determines whether or not each chorus section is the non-standard chorus section based on whether or not each chorus section is temporally adjacent to another chorus section.

4. The information processing apparatus according to claim 2,
wherein the determining unit determines whether or not each chorus section is the non-standard chorus section based on whether or not a key in each chorus section is modulated from a key in another chorus section.

5. The information processing apparatus according to claim 2,
wherein the determining unit determines that a chorus section corresponding to a large chorus present at an end part of the musical piece is the non-standard chorus section.

6. The information processing apparatus according to claim 2,
wherein the determining unit determines whether or not each chorus section is the non-standard chorus section based on a vocal presence probability in each chorus section.

7. The information processing apparatus according to claim 6,
wherein the determining unit compares the vocal presence probability in each chorus section with a threshold value dynamically decided according to a vocal presence probability throughout the musical piece, and determines whether or not each chorus section is the non-standard chorus section.

8. The information processing apparatus according to claim 1,
wherein the setting unit selects one of the standard chorus sections determined by the determining unit as a reference section, and sets the extraction range to the musical piece such that the selected reference section is at least partially included in the extraction range.

9. The information processing apparatus according to claim 8,
wherein the data acquiring unit further acquires chorus likelihood data representing a chorus likelihood of each of the plurality of sections calculated by executing audio signal processing on the musical piece, and
wherein the setting unit selects, as the reference section, a section that is highest in the chorus likelihood represented by the chorus likelihood data among the standard chorus sections determined by the determining unit.

10. The information processing apparatus according to claim 8,
wherein the setting unit selects, as the reference section, a section that is highest in a vocal presence probability among the standard chorus sections determined by the determining unit.

11. The information processing apparatus according to claim 9,
wherein, when there is no section that is determined as the standard chorus section by the determining unit, the setting unit selects, as the reference section, a section that is highest in a vocal presence probability among sections included in the musical piece other than a chorus section.

12. The information processing apparatus according to claim 8,
wherein the setting unit sets a vocal absence point in time ahead of the selected reference section as a starting point of the extraction range.

13. The information processing apparatus according to claim 12,
wherein the setting unit sets the vocal absence point in time closest to the reference section as the starting point of the extraction range.

14. The information processing apparatus according to claim 12,
wherein, when a time length of the extraction range is longer than a time length of the reference section, the setting unit sets, as the starting point of the extraction range, the vocal absence point in time selected such that the reference section is included further rearward in the extraction range.

15. The information processing apparatus according to claim 1, further comprising
an extracting unit that extracts a part corresponding to the extraction range set by the setting unit from the musical piece.

16. The information processing apparatus according to claim 1, further comprising
a communication unit that transmits extraction range data specifying the extraction range to a device that extracts a part corresponding to the extraction range set by the setting unit from the musical piece.

17. An information processing method executed by a control unit of an information processing apparatus, the information processing method comprising:
acquiring section data identifying chorus sections among a plurality of sections included in a musical piece;
determining a standard chorus section among the chorus sections identified by the section data according to a predefined determination condition for discriminating the standard chorus section from a non-standard chorus section; and
setting an extraction range at least partially including the determined standard chorus section to the musical piece.

18. A program for causing a computer controlling an information processing apparatus to function as:
a data acquiring unit that acquires section data identifying chorus sections among a plurality of sections included in a musical piece;
a determining unit that determines a standard chorus section among the chorus sections identified by the section data according to a predefined determination condition for discriminating the standard chorus section from a non-standard chorus section; and
a setting unit that sets an extraction range at least partially including the determined standard chorus section to the musical piece.
